(19) United States
(12) Patent Application Publication
(10) Pub. No.: US 2007/0257389 A1
(43) Pub. Date: Nov. 8, 2007

(54) Imprint Mask and Method for Defining a Structure on a Substrate

(76) Inventor: Alexander Ruf, Dresden (DE)

Correspondence Address: SLATER & MATSIL, L.L.P., 17950 PRESTON ROAD, SUITE 1000, DALLAS, TX, 75252, US

(21) Appl. No.: 11/741,603

(22) Filed: Apr. 27, 2007

(30) Foreign Application Priority Data
Apr. 28, 2006 (DE) 10 2006 019 962.6

(51) Int. Cl. B29C 41/02; B29C 41/52

(52) U.S. Cl. 264/40.1; 264/319; 425/385; 425/138

(57) ABSTRACT

An imprint mask for defining a structure on a substrate is provided with a probe which generates a signal as a function of the displacement of the probe by a force with a lateral component. The imprint mask is aligned relative to a substrate with an alignment mark based upon an interaction of the probe and the alignment mark.

This application claims priority to German Patent Application 10 2006 019 962.6, which was filed Apr. 28, 2006 and is incorporated herein by reference.

### TECHNICAL FIELD

The invention relates to an imprint mask for defining a structure on a substrate in particular by embossing a pattern into a layer on the substrate and to a method for defining a structure on a substrate.

### SUMMARY OF THE INVENTION

During manufacturing of integrated circuits different photolithographic techniques are employed in order to achieve structural dimensions as low as 90 nm during production. Nowadays, lithographic processes are developed, which should achieve structural dimensions as low as 40 nm. Substantially, this can be achieved by using exposure tools with lower wavelength, improved mask technologies as, for example, using phase shift masks, and further developments in resist technology.

Structural dimensions of 40 nm or lower arrive at the limits of optical lithography, so that a transition to lithography in EUV-wavelengths (10 to 15 nm) can be expected. A fundamental difference between optical lithography and lithography in the extreme UV range is given by the application of reflection masks instead of transmissive masks. The transition to EUV-lithography is therefore not only connected with a huge amount of further research but also with higher costs.

One alternative is provided by the adoption of so-called nano imprint masks. This technology is well-known and is successfully used during manufacturing of compact disks (CDs) or DVDs. A substrate is coated by a layer, which needs to be structured. An imprint mask, also known as an embossing-master, has a mirror inverted pattern of the desired structure. The mask is then pressed together with the structure onto the layer on the substrate. In this way the desired pattern is imprinted as a three-dimensional copy of the desired structure.

Applying this concept to semiconductor substrates, the situation is comparable to what has been achieved after development of an exposed photo resist layer. Afterwards, etching steps can be applied in order to transfer the structured pattern of the imprinted layer into the underlying substrate or any further layer.

Nano imprint technology has several benefits, as high accuracy and repeatability of the transfer of the pattern, low costs and, in particular, high throughput. Furthermore, it is possible to avoid often used double exposure steps during optical lithography, when patterns in a dense periodic arrangement are combined with single isolated structures. In addition, there are proposals to perform the so-called dual damascene technique with only one imprint mask instead of two optical masks, wherein trenches and underlying deep contact holes should be formed in the same layer (Stuart et al., “Direct Imprinting of Dielectric Materials for Dual Damescene Processing,” SPIE Microlithography Conference, February 2003).

In general, nano imprint technologies are subdivided into two rather similar concepts, hot and cold embossing.

When using hot embossing, the coated layer on the substrate is usually provided as a polymer (PMMA as an example). The substrate and, if necessary, the imprint mask are heated up to a point that a characteristic temperature for a glass transition is reached. With high pressure, the imprint mask is then pressed into the low viscosity polymer layer. Afterwards, cooling is performed in order to reach a temperature below the glass transition temperature so that the structured polymer layer is annealed.

This annealing temperature is still higher than the surrounding temperature, which means that the substrate and the mask can be easily detached from each other. For hot embossing technology usually the mask is formed consisting of nickel or silicon in order to be able to achieve high temperatures and high aspect ratios for the structured pattern of the desired pattern.

Cold embossing usually employs UV radiation in order to heal the embossed layer. The embossing itself takes place at room temperature. As a suitable layer a photo-polymerized low viscosity ink or monomer can be used. As a result only low forces need to be applied during embossing by the mask.

Conceivable materials for the imprint mask are, for example, quartz glass or PDMS. These materials are transparent with respect to UV radiation between 350 and 450 nm wavelength and allow the heating with UV within a mask aligner while the imprint mask is still in an embossing condition. Furthermore, the transparency of the mask allows an optical alignment with respect to the substrate.

Nano imprint lithography (NIL) is even more beneficial, when only one layer on the substrate needs to be structured. The alignment can be rather coarse with respect to the cusp of the substrate.

### BRIEF DESCRIPTION OF THE DRAWINGS

For a more complete understanding of the present invention, and the advantages thereof, reference is now made to the following descriptions taken in conjunction with the accompanying drawings, in which:

FIGS. 1A to 1D, shown collectively as FIG. 1, shows a prior art process for hot embossing or cold embossing; and

FIGS. 2 to 10 show different embodiments in side views.

### DETAILED DESCRIPTION OF ILLUSTRATIVE EMBODIMENTS

There is a need to further improve the achievable accuracy during alignment for nano imprint lithography.

Furthermore, there is a need to improve the alignment accuracy of the imprint mask with respect to the substrate or, even more precisely, the pattern of the imprint mask with respect to already structured layers on the substrate. Conventional mask alignment for the manufacturing of micro-electromechanical systems usually achieves accuracies in the order of several hundred nanometers up to 1 μm. For semiconductor manufacturing of integrated circuits with structural dimensions as low as 50 nanometer alignment accuracies as low as 1 to 2 nanometer are required.

A drawback of present optical lithography is the stiffness of the optical transparent mask. In case the semiconductor wafer is locally bent or gets bent during processing, no correction is available. For nano imprint lithography it is conceivable to correct local bending, as the imprint mask is not used as an optical element. This means that global bending can be corrected by mechanical twisting of the imprint mask. Local bending could be corrected by thermal heating of the mask. Accordingly, there is a need to optimize the mask and provide a suitable material in order to allow correction means.

Embodiments of imprint masks for defining a structure on a substrate and methods and systems for defining a structure on a substrate are discussed in detail below. It is appreciated, however, that the present invention provides many applicable inventive concepts that can be embodied in a wide variety of specific contexts. The specific embodiments discussed are merely illustrative of specific ways and do not limit the scope of the invention.

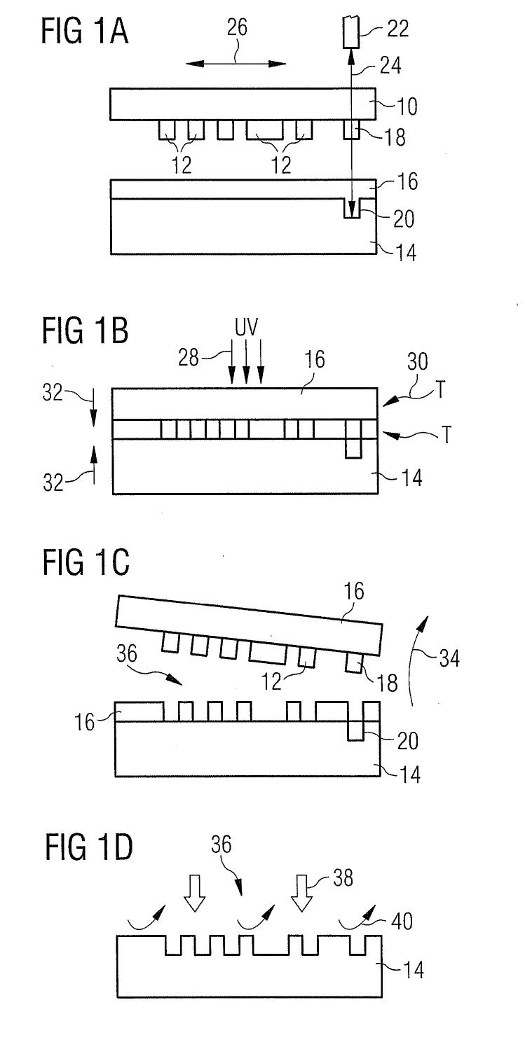

FIG. 1 shows a known process sequence of hot or cold embossing according to a prior art process. In FIG. 1A a substrate 14 and an imprint mask 10 are provided. The imprint mask 10 has structural elements 12 which are arranged on a surface oriented towards the substrate 14 and which represent the actual pattern in a mirror inverted way. The substrate 14 can be fabricated from monocrystalline silicon onto which one or more layers or layer systems are arranged. The layer system can be used for manufacturing integrated circuits and can already be structured.

On top of the substrate or the layer system a layer 16 is arranged. Layer 16 can be fabricated from a polymer or monomer layer. Layer 16 is supposed to be structured.

First, the imprint mask is aligned with respect to the substrate. In order to do so, alignment structures 18 and 20 are arranged on the mask and the substrate, which can overlay by lateral movement 26 of the imprint mask and with the help of an alignment beam 24 and an alignment optic 22.

FIG. 1B shows the embossing process. During embossing 32 the mask 10 is pressed into layer 16 on top of substrate 14. When employing hot embossing processes simultaneously a heating 30 of mask 10 and substrate 14 is performed.

During cold embossing the, in this case, transparent mask 10 is irradiated by UV-light 28 having a wavelength between 350 and 450 nm in order to expose layer 16 which can be a photo polymerized ink. The result is a healing or strengthening of layer 16.

FIG. 1C shows the process of detaching 34 of mask 10 from layer 16 or substrate 14, respectively. FIG. 1D shows the state after a further etching 38 and the complete removal 40 of layer 16 from the surface of substrate 14. The layer pattern 36 has now been transformed in the substrate.

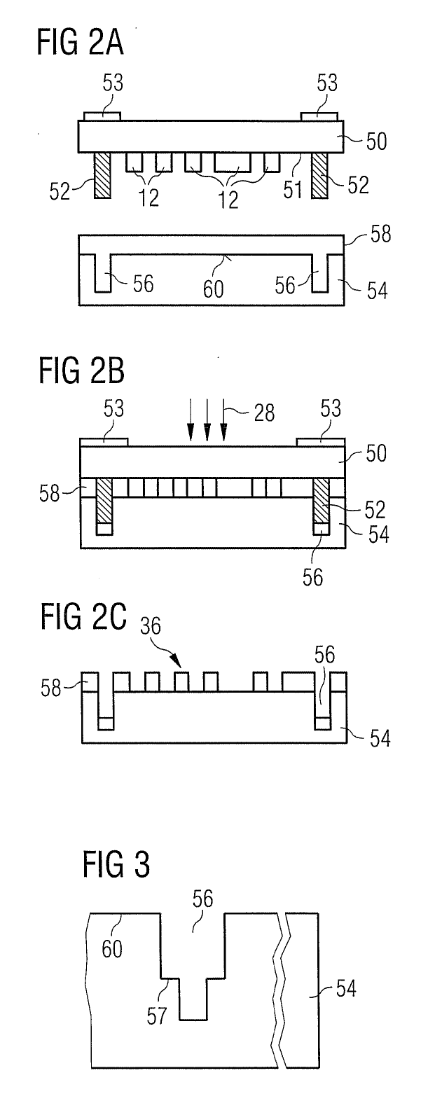

FIG. 2, which includes FIGS. 2A to 2C, shows a first embodiment. In FIG. 2A the imprint mask 50 and substrate 54 are provided. Besides structural elements 12 which belong the desired pattern 36, further elements 52 are arranged which are facing the surface 51 oriented towards the substrate and can be used during the alignment procedure.

Substrate 54 is similar to FIG. 1 coated with a layer 58 which shall be structured. Alignment elements 52 as associated with elements 56 which are arranged on the corresponding side of the surface 60 of substrate 54 as trenches. The length of alignment element 52 is adapted to the depth of the trenches.

FIG. 2B depicts substrate 54 and the imprint mask 50 during embossing. The structural elements are embossed into layer 58. Accordingly, structural elements have a height on the surface 51 which is approximately identical to the thickness of layer 58.

Adjustment elements 52 can have a height being substantially larger than the structural elements. Accordingly, adjustment elements do not only break through layer 58 but also move into the trenches of elements 56 in substrate 54. FIG. 2C shows the state of the transformed pattern 36 after removing tee imprint mask 50.

Only in this example of a transparent imprint mask 50 are opaque structures 53 arranged, which prevent exposure in the region of elements 56 during radiation with UV-light. Accordingly, structural elements 52 can be easily removed and detached from the trenches of elements 56.

Furthermore, it should be noted that during embossing and healing the imprint mask is fixed to the substrate because of elements 52 which are introduced into trenches of elements 56 in the substrate. Accordingly, mechanical drifts can be avoided during embossing and healing.

FIG. 3 shows a further embodiment. Similar reference signs show similar elements as compared to FIG. 2. According to this embodiment the element 56 is adapted to define the end position during the approach of the imprint mask onto the substrate. This can be achieved by, for example, implementing a step-like profile at the lower part of the trench 56. The step-like profile is shown in FIG. 3 as an edge 57. It should be noted, however, that other topological elements can be used which allow for an end point definition, for example, given elements in trench 56 which prevent the element 52 from further moving into the trench.

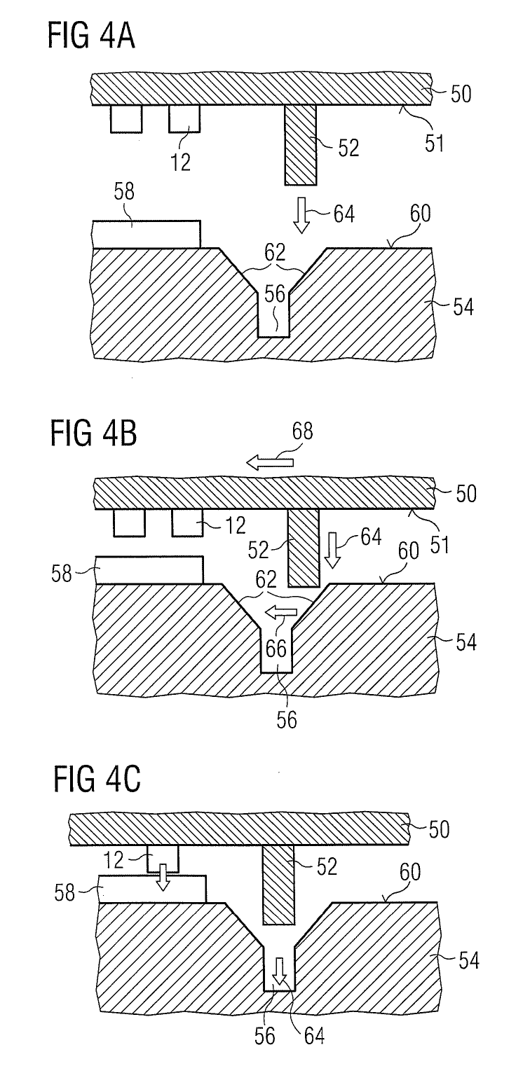

FIG. 4, which includes FIGS. 4A to 4C, shows a further embodiment. Again similar reference signs denote similar elements as compared to FIG. 2. Here, element 56 has inclined sidewalls 62 in a region close to the surface 60 of substrate 54. In the lower region element 56 has substantially the same diameter as the associated adjustment element 52 of imprint mask 50, in order to allow low tolerances. Furthermore, layer 58 has been removed in the vicinity of elements 56 on surface 60 prior to adjustment by applying, for example, given a conventional mask process.

As shown in FIG. 4A, a vertical movement 64 is performed. The adjustment element 52 at once touches the sidewalls 62 of element 56 (FIG. 4B). Accordingly, a lateral force 66 is generated which results in a lateral movement 68 of imprint mask 50 (or alternatively of substrate 54 in opposite direction).

As shown in FIG. 4C, the adjustment element approaches the trench of element 56 in a self-adjusting manner. Further vertical movement 64 causes immediately the embossing of structural element 12 in layer 58 in order to perform the embossing step with the desired pattern 36.

The trench of element 56 can be formed conically in the region of the inclined surface 62. Other geometrical shapes are conceivable as well.

FIG. 5 shows a further embodiment of the imprint mask. Here, alignment element 52a is a tip which is formed electrically conducting as a probe. The tip is connected to a voltage source 70 which can produce a certain bias voltage between the tip and the substrate.

In order to align the imprint mask the tip 52a is moved across the surface 60 of substrate 54 in lateral direction 76. The tip 52a is moved as close to the surface 60 that a tunnel current 74 can flow. The tunnel current is measured with the current measurement system 72. The tunnel current can typically be held constant by an actuator which moves the tip 52a away from the surface of the substrate in case the tunnel current exceeds a certain value or moves the tip closer to the surface in case a current goes below a certain value. The setting value of the actuator is a measure for the distance 100 of tip 52a to surface 60. The working principle is similar to an atomic force microscope.

In the region of the trench of element 56, the distance increases. In response to that signal, i.e., a change of the measured current, the position of the adjustment element can be modified.

Another conceivable embodiment uses a scanning procedure to first measure the surface on a grid around alignment element 56. The measured data can be used to determine the exact position in coordinates of the substrate. Afterwards, mask 50 or substrate 54 can be moved such that both are arranged relative to each other within a certain required accuracy.

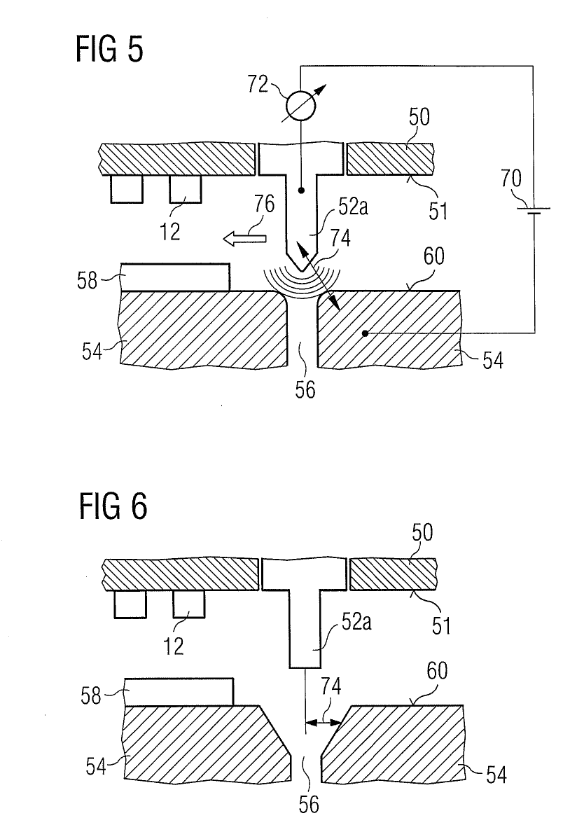

A further embodiment is shown with respect to FIG. 6. There, tip 52a is formed as a probe and again measures a tunnel current as explained in the previous embodiment. Furthermore, the measurement is now used to determine the horizontal position 74. It should be noted that a misalignment of tip 52a results in an increasing tunnel current which is directly proportional to the misalignment. Accordingly, the tunnel current serves as a reference value to obtain optimized substrate holder coordinates which can be used further on to align mask 50 and substrate 54 with respect to each other.

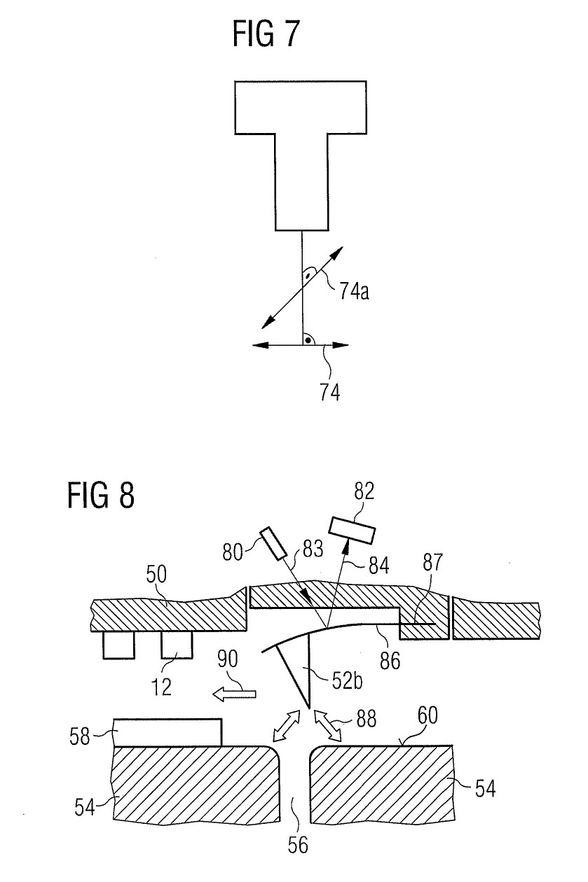

This concept is furthermore extended by using a two-dimensional measurement which can be achieved when using a dual tip probe. Accordingly, as indicated in FIG. 7, the dual tip probe 52a provides a horizontal measurement 74 and in addition, along another coordinate, a second measurement 74a. The two coordinates can be selected substantially perpendicular to each other when using a dual tip probe. As a result, a measurement of the relative misalignment between mask 50 and substrate 54 can be performed without scanning the surface 60 of substrate 54, as explained with respect to FIG. 5.

It should be noted that the dual tip probe as described with respect to FIG. 7 not only increase the relative alignment between the mask 50 and substrate 54, but also serves as a control signal during the last part of the approach of the imprint mask 50 and the substrate 54. As the relative position is known in two dimensions with respect to the plane of the substrate 54, it is even conceivable to correct the embossing process itself when the imprint mask moves into layer 56. According to this procedure, the accuracy of the embossing process can be increased even further.

FIG. 8 shows a further embodiment. Here, an alignment element 52b is provided which is controlled similarly to atomic force microscope. Attached to a bendable lever arm 86 is a tip 52b which has, for example, a bending radius between 10 and 20 nm in order to achieve a resolution in the range between 0.1 and 10 nm. The bendable element 86 is fixed to mask 50 in the region 87. A radiation source 80 generates a focused light beam 83 which is reflected from the rear side of the bendable lever arm 86 and collected by a detector 82. Detector 82 detects changes of the bending of element 86 caused by the interaction 88 of the tip 52b with surface 60 of the substrate 54.

As described with respect to the previous embodiments, the signal of detector 82 can be used to determine the lateral relative positioning between mask 50 and substrate 54. It should be noted that the dual tip probe which was described with respect to FIG. 7, can also be implemented in a configuration as shown in FIG. 8. Similar to atomic force microscopes, the interaction 88 is caused by repelling forces of different electron orbits between atoms in surface 60 and tip 52b according to the Pauli principle.

In another conceivable embodiment, tip 52b can be adjusted to a permanent contact level which means that the distance to the substrate is held constant or can be scanned in both directions in order to determine the profile of surface 60.

Besides the operating mode of an atomic force microscope, also a so-called intermittent mode can be established. There, further interactions and forces appear which result in an attraction of the tip from the surface of the substrate by van der Waals forces. Accordingly, the tip can be deliberately stimulated to oscillations across the bendable element while the van der Waals forces reduce the amplitude and/or frequency of the oscillation.

In the so-called non-contact mode, the bendable element is stimulated above its resonance frequency. The intermediate mode works slightly below the resonance frequency. Below the resonance frequency energy is transformed into the bendable element in case the attracting forces act upon the bending element because of a further approach with respect to the surface of substrate 54. As a result, so-called tapping is observed which results in higher amplitudes and also a contact with the surface.

In this embodiment, it is difficult to simultaneously perform further measurements for different elements 52b. Accordingly, piezo elements or actuators 110 can be included which can retract or extend different elements 52a or 52b vertically in order to perform different measurements for different positions along the substrate 54. This is schematically shown in FIGS. 10A and 10B.

It should be noted that not all alignment elements 52, 52a or 52b can simultaneously find the proper position with respect to the respective element 56. This can be due to the fact that mask 50 is twisted with respect to the substrate. By performing local or global bending of mask 50, the relative twist can be removed.

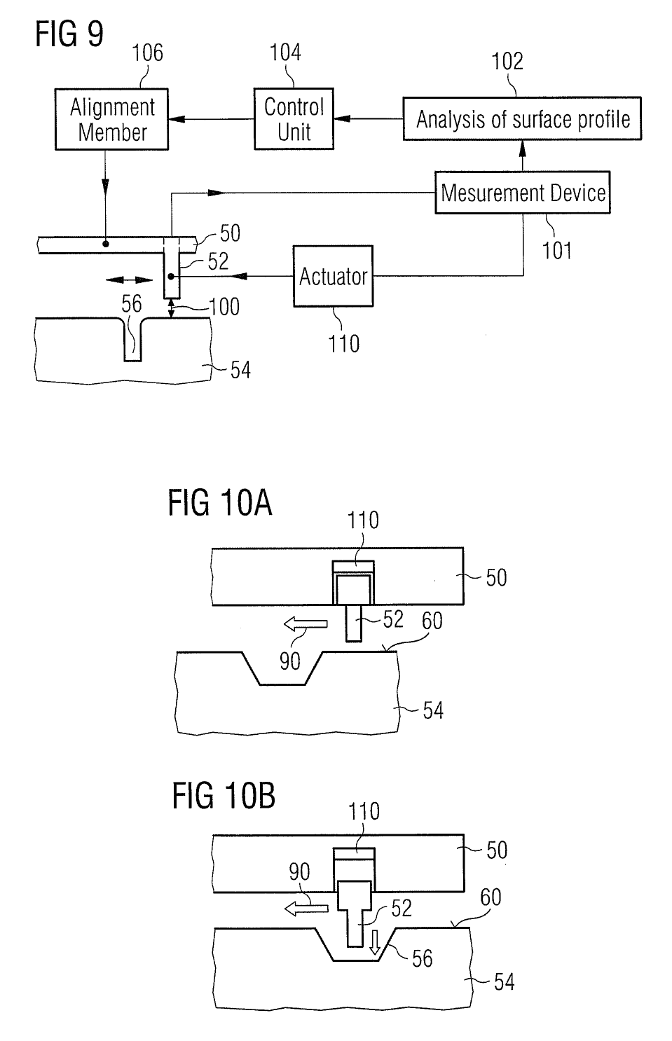

FIG. 9 shows schematically a system for structuring a substrate with an imprint mask 50. The system includes a control part which adjusts the imprint mask 50 with respect to the substrate 54. The signal is derived from alignment element 52, as described above. Alignment element 52 is connected to a measurement device 101 which serves as an actuator 110 of the tip. The measurement device 101 sends data to a surface profile analysis unit 102. Here, mask coordinates and profile data are collected. A position of element 56 is calculated in coordinates with respect to mask 50. The position is forwarded to control unit 104 which controls an alignment member 106 which provides a lateral force with respect to mask 50 depending on a signal of the control unit 104. The lateral force moves mask 50 in the ideal or best alignment position.

Having described embodiments of the invention, it is noted that modifications and variations can be made by persons skilled in the art in light of the above teachings. It is therefore to be understood that changes may be made in the particular embodiments of the invention disclosed which are within the scope and spirit of the invention as defined by the appended claims. Having thus described the invention with the details and the particularity required by the patent laws, what is claimed and desired to be protected by Letters Patent is set forth in the appended claims.

What is claimed is:

1. An imprint mask for defining a structure on a substrate, the imprint mask comprising a probe configured to generate a signal as a function of displacement of the probe by a force with a lateral component.

2. The imprint mask according to claim 1, wherein the lateral component of the force is generated while approaching a substrate by mechanical interaction.

3. The imprint mask according to claim 2, wherein the lateral component of the force has a direction towards an ideal position of the mask.

4. The imprint mask according to claim 1, wherein the probe comprises a structural element on the mask, the structural element having a height exceeding a height of structural elements used for defining a structure.

5. The imprint mask according to claim 4, wherein the structural element is configured to engage with an opening on a substrate, the opening having inclined sidewalls.

6. The imprint mask according to claim 1, wherein the probe is configured to generate a stop signal when reaching an end point of an approach to a substrate.

7. The imprint mask according to claim 6, wherein the stop signal is generated mechanically.

8. The imprint mask according to claim 1, wherein the probe comprises a tip configured to generate the signal during interaction with the substrate by electric or electrostatic interaction.

9. The imprint mask according to claim 8, wherein the function of the displacement is derived from a distance between the tip and a sidewall within the substrate.

10. The imprint mask according to claim 8, wherein the probe comprises a dual tip configured to generate the signal during interaction with the substrate by an electric or electrostatic lateral force for two substantially different lateral directions.

11. The imprint mask according to claim 8, wherein the signal is generated until the final approach position of the mask on the substrate has been reached.

12. The imprint mask according to claim 8, wherein the probe comprises a bendable lever arm onto which the tip is arranged.

13. The imprint mask according to claim 12, further comprising a detector operable to detect a bending of the lever arm during an approach of the tip with a surface of a substrate.

14. The imprint mask according to claim 13, wherein the detector is configured to measure an optical, resistive, capacitive or piezo-electric signal.

15. The imprint mask according to claim 1, further comprising an actuator for lateral movement of the mask relative to the substrate.

16. The imprint mask according to claim 1, wherein the tip of the probe is configured to be electrically conducting.

17. The imprint mask according to claim 16, wherein the tip is further connected to a measurement unit, the measurement unit being configured to generate a signal during approach of the tip with the substrate.

18. The imprint mask according to claim 8, further comprising at least one further probe.

19. A method for defining a structure on a substrate, the method comprising:
aligning an imprint mask relative to a substrate that includes an alignment mark and a sidewall, the aligning being based upon an interaction of a probe with the sidewall.

20. The method according to claim 19, further comprising approaching the mask to the substrate, the aligning and the approaching being performed simultaneously.

21. The method according to claim 19, wherein the interaction effects a lateral component of a mechanical force.

22. The method according to claim 21, wherein the lateral component of the force has a direction towards an ideal position of the mask.

23. The method according to claim 22, wherein the probe comprises a structural element on the mask, the structural element having a height exceeding a height of structural elements used for defining a structure.

24. The method according to claim 23, wherein the structural element engages during approach with an opening on a substrate the opening having inclined sidewalls.

25. The method according to claim 24, wherein the structural element is conically shaped.

26. The method according to claim 19, wherein the mask stops engaging into the substrate when reaching an end point of an approach.

27. The method according to claim 19, wherein the interaction of the probe with the sidewall generates an electric or electrostatic force on a tip.

28. The method according to claim 27, wherein a displacement is derived from a distance between the tip and a sidewall within a substrate.

29. The method according to claim 28, wherein the probe comprises a dual tip configured to measure a displacement for two substantially different lateral directions.

30. A method for defining a structure on a substrate, the method comprising:
providing a substrate that is coated with a layer and has at least one alignment mark with a sidewall;
providing an imprint mask having structural elements according to a desired pattern and a further probe element;
approaching the mask to the substrate;
aligning the imprint mask relative to the substrate based upon an interaction between the probe element with the sidewall during the approach.

31. The method according to claim 30, wherein the interaction effects a lateral component of a mechanical force.

32. The method according to claim 30, wherein the probe is configured to generate a signal in response to approaching the substrate, the signal being transformed into a lateral force in order to align the mask relative to the substrate.

33. The method according to claim 30, further comprising, prior to aligning the substrate performing a partial removal of the layer around the alignment mark.

34. The method according to claim 33, wherein the structural elements of the desired pattern are not in contact while the probe approaches the alignment mark.

35. The method according to claim 30, wherein, further comprising performing an optical alignment of the imprint mask and the substrate.

36. The method according to claim 32, wherein the lateral force is provided by an actuator.

37. The method according to claim 36, wherein the actuator is controlled by a control unit, the control unit operating in response to a signal of the probe.

38. The method according to claim 37, wherein the signal of the probe is a function of a vertical displacement between the probe and the sidewall.

39. The method according to claim 38, wherein the probe is electrically conducting and the function is represented by a tunnel current between the probe and the sidewall.

40. The method according to claim 39, wherein the probe comprises a bendable lever arm onto which the tip is arranged and detects a bending of the lever arm during an approach of the tip with the sidewalls of the alignment mark.

41. A structuring system comprising:
a mask comprising a probe configured to generate a signal as a function of the displacement of the probe by a force with a lateral component; and
a controller configured to align the mask based on the probe signal.
